(19) United States
(12) Patent Application Publication
(10) Pub. No.: US 2007/0081725 A1
(43) Pub. Date: Apr. 12, 2007

(54) System and Method For Shape Regulation of Segmented Target Objects

(75) Inventor: Lin Hong, Monmouth Junction, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH INC, PRINCETON, NJ (US)

(21) Appl. No.: 11/537,671

(22) Filed: Oct. 2, 2006

Related U.S. Application Data
(60) Provisional application No. 60/724,532, filed on Oct. 7, 2005.

(51) Int. Cl. G06K 9/34; G06K 9/00

(52) U.S. Cl. 382/173; 382/131

(57) ABSTRACT

A method for regulating an object segmentation result to conform a shape of the object segmentation result to a pseudo-round type of shape includes: calculating a set of shape-constraint measures at each point on a boundary of an object segmentation result; searching for one or more matched point pairs on the boundary of the object segmentation result; and replacing a boundary segment between a selected matched point pair with a smooth curve.

### CROSS-REFERENCE TO RELATED APPLICATION

This application claims the benefit of U.S. Provisional Application Ser. No. 60/724,532 (Attorney Docket No. 2005P18276US), filed Oct. 7, 2005 and entitled “A Method for Shape Regulation Using a-Convex-Shape-Constraint”, the content of which is herein incorporated by reference in its entirety.

### BACKGROUND OF THE INVENTION

1. Technical Field

The present disclosure relates to object segmentation and, more particularly, to methods and systems for regulating an object segmentation result.

2. Discussion of Related Art

In object segmentation application scenarios such as lesion or anatomical structure segmentation in two- or three-dimensional medical images, intensity distribution itself does not provide sufficient cues to differentiate the target objects from the typically rich backgrounds. Additional mechanisms need to be used to help a vision algorithm produce an acceptable result. Shape constraint techniques which regulate the segmented object using shape cues may be used.

For example, in the liver tumor segmentation scenario, a liver tumor is typically a simple shaped object. To segment a liver tumor from a computed tomography (CT) image, generally it is necessary to establish a discriminating function of the liver tumor based on intensity distribution. However, such a discriminating function may produce a segmentation result that includes a significant amount of misclassified voxels. FIGS. 1A and 1B show examples of simple shaped target objects and neighboring objects with an intensity distribution similar to that of the target objects. FIG. 1A is the raw image slice. FIG. 1B shows the corresponding likelihood field.

A constraint may be imposed on the configuration of the segmented target object to avoid including the misclassified non-target voxels in the segmentation. To impose a constraint on the segmentation result, additional information needs to be used. In general, it is not desirable to request the user to provide additional interactive inputs.

Shape feature is a cue that can be used in regulating the segmentation result. A shape property that characterizes target objects in the liver tumor segmentation scenario, for example, is that the target objects are simple shaped objects which may exhibit significant variations. FIGS. 2A through 2H show examples of the two-dimensional boundaries of three target objects, which were marked by physicians. As shown in FIGS. 2A through 2H, the target object is next to anatomical structures with an intensity distribution similar to that of the target object.

Traditional shape constraint techniques, including active shape model, smoothness constraint measures such as integration of derivatives, and shape factor, are all ineffective to constrain the configuration of target objects with simple shapes but exhibiting significant variations.

Active shape model establishes statistical models from a batch of variations of target shapes, which can then be used to guide the target object segmentation. This technique performs reasonably well when there are no significant variations in target objects. It can handle complex objects with some internal structures and missing parts and occlusion, but is not suitable for scenarios where target objects of simple shape exhibit significant variations.

Learning based techniques which capture statistical shape properties as shape prior knowledge are not able to provide sufficient cues to regulate the target object segmentation. Level set based techniques may provide elegant approaches to embed shape constraint in the level set function, but do not address the shape constraint itself. Smoothness constraints such as integration of derivatives do not provide much help in differentiating the target objects from backgrounds. Other shape measures such as shape factors do not enable a valid mechanism to be established to regulate the segmented shape. A need exists for an effective shape constraint measure on simple target objects which is capable of handling significant object variations.

### SUMMARY OF THE INVENTION

According to an exemplary embodiment of the present invention, a method is provided for regulating an object segmentation result to conform a shape of the object segmentation result to a pseudo-round type of shape. The method includes: calculating a set of shape-constraint measures at each point on a boundary of an object segmentation result; searching for one or more matched point pairs on the boundary of the object segmentation result; and replacing a boundary segment between a selected matched point pair with a smooth curve.

According to an exemplary embodiment of the present invention, a system for regulating an object segmentation result to conform a shape of the object segmentation result to a pseudo-round type of shape comprises: a memory device for storing a program; a processor in communication with the memory device, the processor operative with the program to: calculate a set of a shape-constraint measures at each point on a boundary of an object segmentation result; search for one or more matched point pairs on the boundary of the object segmentation result; and replace a boundary segment between a selected matched point pair with a smooth curve.

According to an exemplary embodiment of the present invention, a method is provided for regulating a shape of an object segmentation result. The method includes: defining a set of shape-constraint measures to regulate segmented target objects; searching for a pair of matched points on a boundary of an object segmentation result; and interpolating between the matched points using local shape properties.

### BRIEF DESCRIPTION OF THE DRAWINGS

The present invention will become more apparent to those of ordinary skill in the art when descriptions of exemplary embodiments thereof are read with reference to the accompanying drawings.

FIGS. 1A and 1B show examples of simple shaped target objects and neighboring objects with an intensity distribution similar to that of the target objects.

FIGS. 2A through 2H show examples of the 2D boundaries of three target objects, which were marked by physicians.

FIG. 3 is a flowchart showing a method of regulating an object segmentation result to conform a shape of the object segmentation result to a pseudo-round type of shape, according to an exemplary embodiment of the present invention.

FIGS. 4A through 4D show examples of the estimated likelihood fields of target objects, according to an exemplary embodiment of the present invention.

FIG. 5 illustrates a computer system for implementing a method of reducing noise in an image sequence, according to an exemplary embodiment of the present invention.

FIG. 6 is a flowchart showing a method of regulating the shape of an object segmentation result, according to an exemplary embodiment of the present invention.

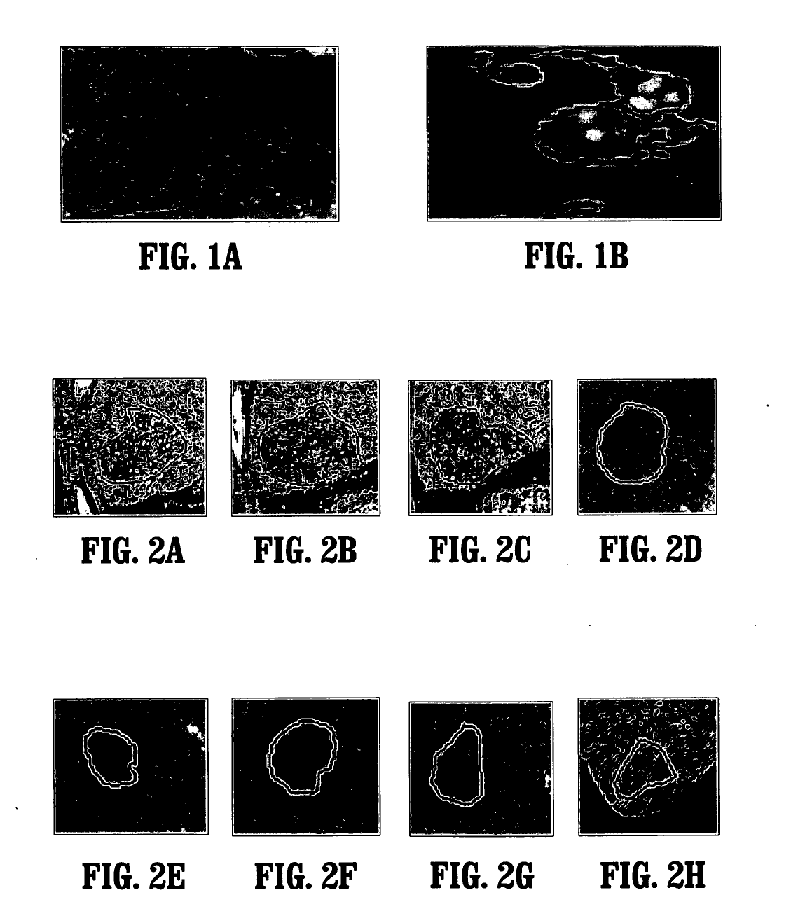

### DESCRIPTION OF EXEMPLARY EMBODIMENTS

Hereinafter, exemplary embodiments of the present invention will be described in detail with reference to the accompanying drawings.

According to an exemplary embodiment of the present invention, a shape constraint technique, referred to herein as “a-convex shape constraint technique” imposes constraints on target object segmentation to ensure that the boundary of the segmentation result conforms to a simple object boundary configuration. This technique defines a shape constrain measure, referred to herein as “a-convex measure”, which is an extension of the mathematic convex concept. For example, the a-convex measure may be derived from a center point of a target object to regulate target object boundary based on the a-convex definition, which will be described later in this disclosure.

The a-convex shape constraint technique regulates target object segmentation using the a-convex measure which conforms the shape of a segmentation result to an a-convex configuration. The technique can be implemented for two-dimensional (2-D) objects as well as three-dimensional (3-D) objects. However, regulating a target object directly in 3-D space is typically difficult to be implemented. In an exemplary embodiment of the present invention, when the object is a 3-D object, the object segmentation result is decomposed to a sequence of 2-D cross sections. Applying the a-convex shape constraint technique, according to exemplary embodiments of the present invention, in the cross sections and then combining the results in these cross sections may be a more efficient approach than to impose an a-convex constraint directly in 3-D space. It is to be understood that various embodiments of the a-convex shape constraint technique may be applied to 2-D images, 3-D images, and/or higher-dimensional images. Hereinafter, the description will be focused on the regulating process in 2-D.

Let b(t)=(x(t), y(t)) be the 2D boundary of a target object, O, where t parameterizes the arc length of the boundary. Define the anchor of a target object, (x_{c}, y_{c}), to be a position in the target object that may be initially provided by user interaction or by other methods. For example, (x_{c}, y_{c}) may be located at the center region of a target object. The regulating process assumes that only one connected component exists when regulating a 2-D object. A 3-D target object may produce more than one 2-D connected components and, in which case, each 2D object can be regulated separately.

According to an exemplary embodiment of the present invention, α(t) denotes a directional angle between a tangent and a directional line to an object center at each curve point, which can be expressed as Equation 1.
α(t)=Φ((∂x(t)/∂t,∂x(t)/∂t)\textcircled{×}(x_{c}−x(t),y_{c}−y(t))), (1)
where \textcircled{×} represents vector product and Φ represents the directional angle between (∂x(t)/∂t, ∂x(t)/∂t) and (x_{c}−x(t),y_{c}−y(t))). As shown in Equation 2, b(t) is characterized as a-convex if

$$\{ \begin{matrix}α ( t ) > 0 & and \\ α ( t ) \leq θ & and \\ ( x , y ) ∈ O , & if ( x - x ( t ) ) ( y - {y}_{c} ) = ( x - {x}_{c} ) ( y - y ( t ) ) and ( x , y ) ∈ [ ( {x}_{c} , {y}_{c} ) , ( x ( t ) , y ( t ) ]\end{matrix} \qquad ( 2 )$$

where α̅(̅t̅)̅ represents a local average of the directional angle in an interval, ε(t), starting from t, and where θ has a value larger than 90 degrees. In an exemplary embodiment of the present invention, θ is a value larger than 90 degrees and less than 180 degrees. ε(t) may be a small constant size, which can accommodate small local variations. In an exemplary embodiment of the present invention the interval ε(t) is of a size between about 1% to about 50% of a curve length For a given value of θ, a-convex may be a measurement criterion that characterizes a family of 2-D shapes that are simple compact shapes with some limit variation in local boundary properties. For example, a circle is a-convex (θ=90°). It is to be understood that the a-convex shape constraint technique can be extended to handle target objects of more complex shape.

FIGS. 4A through 4D show examples of the estimated likelihood fields of target objects, according to an exemplary embodiment of the present invention Examples of shapes that satisfy the a-convex constraint are shown in FIGS. 4A through 4D.

There are various approaches by which the a-convex constraint can be used to constrain segmentation results, For example, a simple approach is to define a cost function on the a-convex equation and to plug it in a PDE-based algorithm. Such an approach may not effectively handle boundary leakages.

In an exemplary embodiment of the present invention, two steps, which may be iteratively performed, are used to regulate the segmentation result: (i) search for the most-significant pair of matched points that are non-a-convex on the boundary b(t), and (ii) interpolate between the matched non-a-convex points using local shape properties. A pair of non-a-convex points may be said to be matched if the a-convex arc segments next to the non-a-convex points are consistent such that a smooth circular curve may be formed between them. The significance measurement of a non-a-convex refers to boundary curvature at the point.

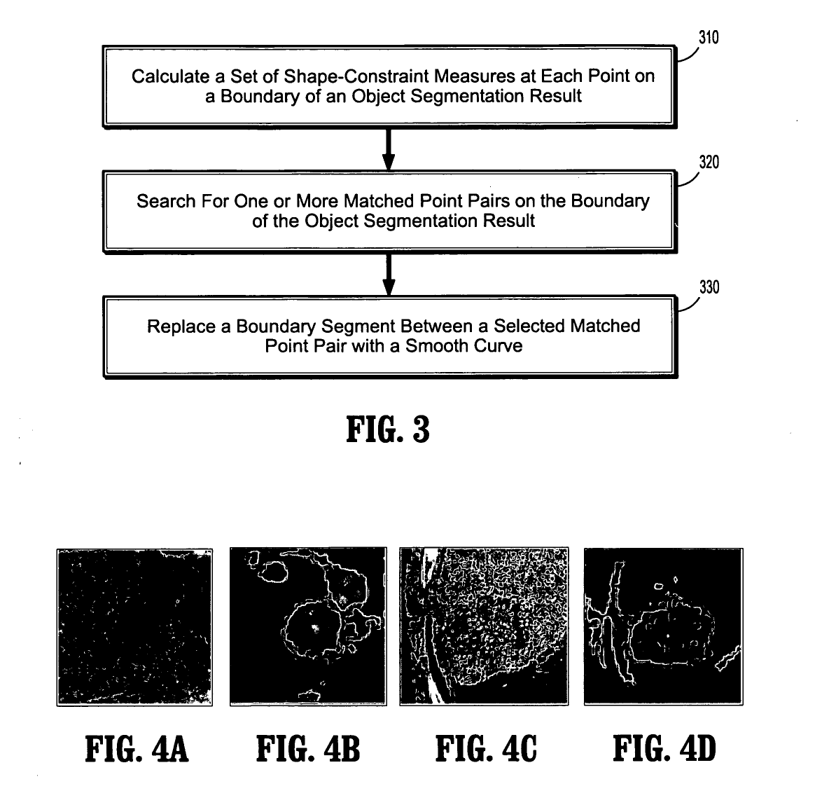

FIG. 3 is a flowchart showing a method of regulating an object segmentation result to conform a shape of the object segmentation result to a pseudo-round type of shape, according to an exemplary embodiment of the present invention. Referring to FIG. 3, in step 310, a set of shape-constraint measures are calculated at each point on a boundary of an object segmentation result.

The set of shape-constraint measures may define a measurement criterion that characterizes a family of two-dimensional shapes. For example, the family of two-dimensional shapes may comprise compact, pseudo-round types of shapes. The shape-constraint measures may be defined based on a single object center. The shape-constraint measures may be defined based on a middle axis segment.

Calculating the set of shape-constraint measures may comprise calculating a directional angle between a tangent and a directional line to an object center at each curve point, calculating a local average of a directional angle in an interval, and checking that substantially all points between a curve point and an object center are inside the object.

With reference to Equation 1, above, calculating the set of shape-constraint measures may comprise calculating α(t) and α̅(̅t̅)̅, where α̅(̅t̅)̅ represents a local average of a first directional angle in an interval ε(t) centered from t, and where α(t)=Φ((∂x(t)/∂t, ∂x(t)/∂t)\textcircled{×}(x_{c}−x(t), y_{c}−y(t))), where \textcircled{×} represents vector product and Φ represents a second directional angle between (∂x(t)/∂t,∂x(t)/∂t) and (x_{c}−x(t),y_{c}−y(t)). Calculating the set of shape-constraint measures may further comprise calculating (x,y)∈O, if (x−x(t))(y−y_{c})=(x−x_{c})(y−y(t)) and (x,y) is between (x(t),y(t)) and (y_{c},x_{c}), where (x(t),y(t)) is a two-dimensional boundary of a target object O, where t parameterizes an arc length of the boundary of the object segmentation result.

In step 320, search for one or more matched point pairs on the boundary of the object segmentation result. In an exemplary embodiment of the present invention, a pair of points on the boundary of the segmentation object are matched point pairs if, at both points, the calculated values of at least one shape-constraint measure of the set of shape-constraint measures does not satisfy a shape-constraint measure condition and arc segments adjacent to the points are pointed towards each other such that a smooth curve may be formed between them.

In step 330, a boundary segment between a selected matched point pair is replaced with a smooth curve.

The calculating step 310, searching step 320 and replacing step 330 may be repeated until no matched pairs can be found for which a calculated value of at least one shape-constraint measure of the set of shape-constraint measures does not satisfy a shape-constraint measure condition.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

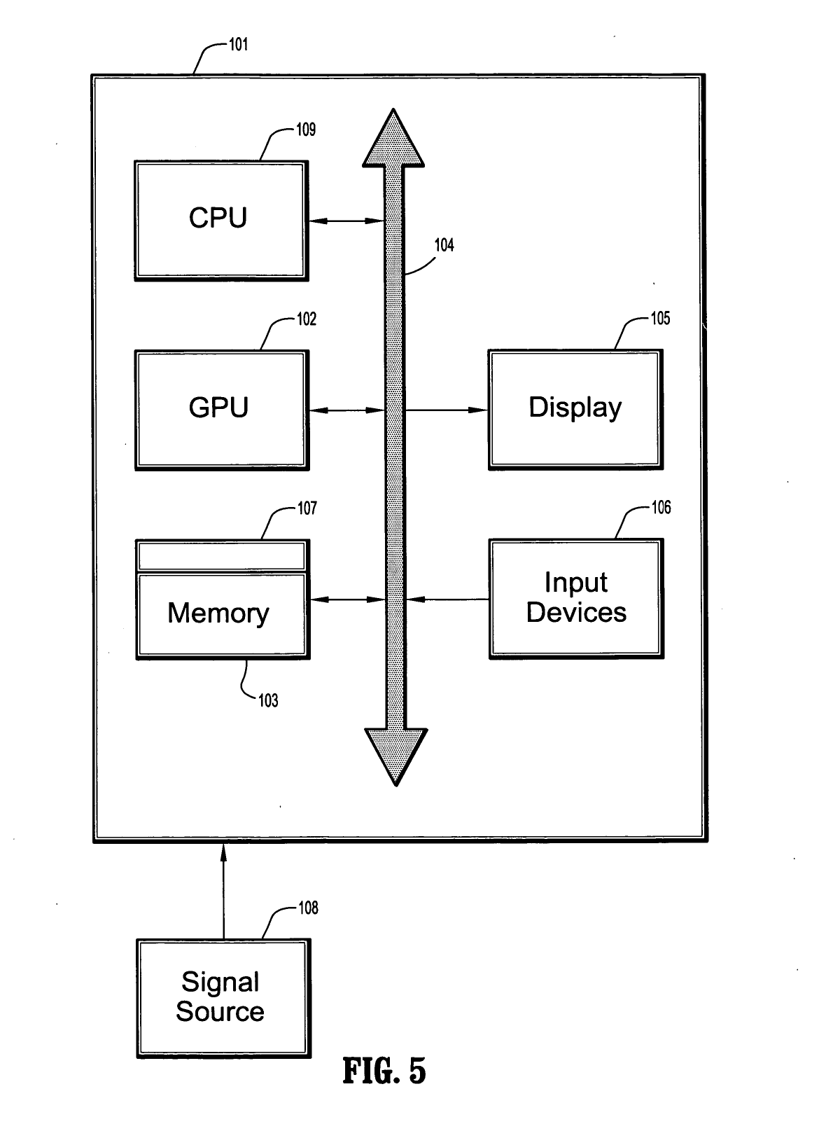

Referring to FIG. 5, according to an embodiment of the present disclosure, a computer system 101 for implementing a method of regulating an object segmentation result to conform a shape of the object segmentation result to a pseudo-round type of shape can comprise, inter alia, a central processing unit (CPU) 109, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 109 to process the signal from the signal source 108, As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

In an exemplary embodiment of the present invention, a system for regulating an object segmentation result to conform a shape of the object segmentation result to a pseudo-round type of shape comprises a memory device 103 for storing a program, and a processor 109 in communication with the memory device 103. The processor 109 is operative with the program to calculate a set of shape-constraint measures at each point on a boundary of an object segmentation result; search for one or more matched point pairs on the boundary of the object segmentation result; and replace a boundary segment between a selected matched point pair with a smooth curve.

Calculating the set of shape-constraint measures may comprise calculating a directional angle between a tangent and a directional line to an object center at each curve point, calculating a local average of a directional angle in an interval, and checking that substantially all points between a curve point and an object center are inside the object. Calculating the set of shape-constraint measures may comprise calculating α(t) and α̅(̅t̅)̅, where α̅(̅t̅)̅ represents a local average of a first directional angle in an interval ε(t) centered from t, and where α(t)=Φ((∂x(t)/∂t,∂x(t)/∂t)\textcircled{×}(x_{c}−x(t), y_{c}−y(t))), where \textcircled{×} represents vector product and Φ represents a second directional angle between (∂x(t)/∂t,∂x(t)/∂t) and (x_{c}−x(t),y_{c}−y(t)).

In an exemplary embodiment of the present invention, the processor 109 is further operative with the program to repeat the calculating, searching and replacing steps until no matched pairs can be found for which a calculated value of at least one shape-constraint measure of the set of shape-constraint measures does not satisfy a shape-constraint measure condition. For example, the shape-constraint measure conditions may comprise α(t)>0 and α̅(̅t̅)̅≦θ, where α̅(̅t̅)̅ represents a local average of a first directional angle in an interval ε(t) starting from t, and where α(t)=Φ((∂x(t)/∂t,∂x(t)/∂t)\textcircled{×}(x_{c}−x(t),y_{c}−y(t))), where \textcircled{×} represents vector product and Φ represents a second directional angle between (∂x(t)/∂t,∂x(t)/∂t) and (x_{c}−x(t),y_{c}−y(t)). In an exemplary embodiment of the present invention, θ is a value larger than 90 degrees and less than 180 degrees. The interval ε(t) may be of a size between about 1% to about 50% of a curve length.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

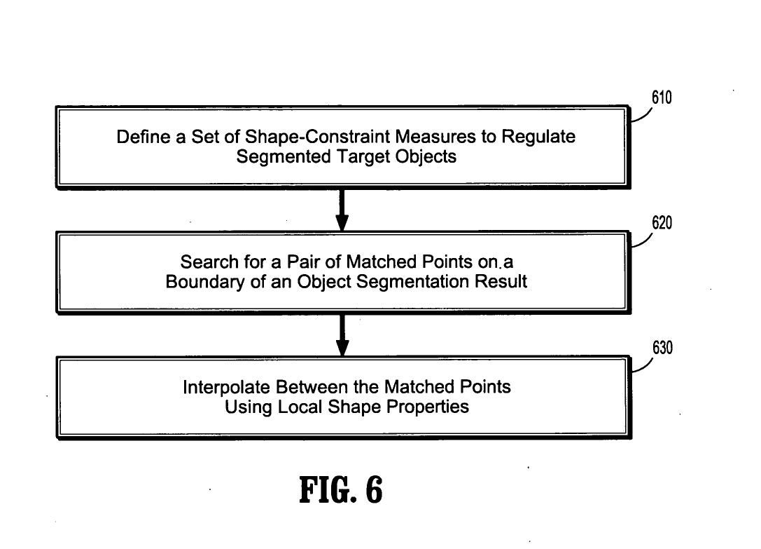

FIG. 6 is a flowchart showing a method of regulating the shape of an object segmentation result, according to an exemplary embodiment of the present invention. Referring to FIG. 6, in step 610, a set of shape-constraint measures is defined to regulate segmented target objects. The set of shape-constraint measures may define a measurement criterion that characterizes a family of two-dimensional shapes. For example, the family of two-dimensional shapes may comprise compact, pseudo-round types of shapes. The shape-constraint measures may be defined based on a single object center. The shape-constraint measures may be defined based on a middle axis segment.

In step 620, search for a pair of matched points on a boundary of an object segmentation result. For example, a pair of points on the boundary of the segmentation object may be matched point pairs if, at both points, the calculated values of at least one shape-constraint measure of the set of shape-constraint measures does not satisfy a shape-constraint measure condition and arc segments adjacent to the points are pointed towards each other such that a smooth curve may be formed between them.

In step 630, interpolate between the matched points using local shape properties.

According to an exemplary embodiment of the present invention, a shape constraint technique uses the a-convex measure to regulate the shape of the segmented target objects. In an exemplary embodiment of the present invention, the segmented target objects are simple shaped target objects that may exhibit significant shape variations. The a-convex measure may be defined based on a single anchor point In an exemplary embodiment of the present invention, the a-convex measure is defined based on a middle axis segment and may significantly improve the flexibility and the expression capability of the shape constraint technique.

Although exemplary embodiments of the present invention have been described in detail with reference to the accompanying drawings for the purpose of illustration, it is to be understood that the inventive processes and apparatus are not to be construed as limited thereby. It will be readily apparent to those of reasonable skill in the art that various modifications to the foregoing exemplary embodiments may be made without departing from the scope of the invention as defined by the appended claims.

What is claimed is:

1. A method of regulating an object segmentation result to conform a shape of the object segmentation result to a pseudo-round type of shape, comprising:
calculating a set of shape-constraint measures at each point on a boundary of an object segmentation result;
searching for one or more matched point pairs on the boundary of the object segmentation result; and
replacing a boundary segment between a selected matched point pair with a smooth curve.

2. The method of claim 1 wherein calculating the set of shape-constraint measures comprises calculating a directional angle between a tangent and a directional line to an object center at each curve point, calculating a local average of a directional angle in an interval, and checking that substantially all points between a curve point and an object center are inside the object.

3. The method of claim 1 wherein calculating the set of shape-constraint measures comprises calculating α(t) and α̅(̅t̅)̅, where α̅(̅t̅)̅ represents a local average of a first directional angle in an interval ε(t) centered from t, and where α(t)=Φ((∂x(t)/∂t,∂x(t)/∂t)\textcircled{×}(x_{c}−x(t),y_{c}−y(t))), where \textcircled{×} represents vector product and Φ represents a second directional angle between (∂x(t)/∂t,∂x(t)/∂t) and (x_{c}−x(t),y_{c}−y(t)).

4. The method of claim 3, further comprising calculating (x,y)∈O, if (x−x(t))(y−y_{c})=(x−x_{c})(y−y(t)) and (x,y) is between (x(t),y(t)) and (y_{c},x_{c}), where (x(t),y(t)) is a two-dimensional boundary of a target object O, where t parameterizes an arc length of the boundary of the object segmentation result.

5. The method of claim 1, wherein the set of shape-constraint measures define a measurement criterion that characterizes a family of two-dimensional shapes

6. The method of claim 5, wherein the family of two-dimensional shapes comprises compact, pseudo-round types of shapes.

7. The method of claim 1, wherein the shape-constraint measures are defined based on a single object center.

8. The method of claim 1, wherein the shape-constraint measures are defined based on a middle axis segment.

9. The method of claim 1l wherein a pair of points on the boundary of the segmentation object are matched point pairs if, at both points, the calculated values of at least one shape-constraint measure of the set of shape-constraint measures does not satisfy a shape-constraint measure condition and arc segments adjacent to the points are pointed towards each other such that a smooth curve may be formed between them.

10. The method of claim 1, further comprising repeating the calculating, searching and replacing steps until no matched pairs can be found for which a calculated value of at least one shape-constraint measure of the set of shape-constraint measures does not satisfy a shape-constraint measure condition.

11. The method of claim 10, wherein the shape-constraint measure conditions comprise α(t)>0 and α̅(̅t̅)̅≦θ, where α̅(̅t̅)̅ represents a local average of a first directional angle in an interval ε(t) starting from t, and where α(t)=Φ((∂x(t)/∂t,∂x(t)/∂t)\textcircled{×}(x_{c}−x(t),y_{c}−y(t))), where \textcircled{×} represents vector product and Φ represents a second directional angle between (∂x(t)/∂t,∂x(t)/∂t) and (x_{c}−x(t), y_{c}−y(t)).

12. The method of claim 11, wherein θ is a value larger than 90 degrees and less than 180 degrees.

13. The method of claim 11, wherein the interval ε(t) is of a size between about 1% to about 50% of a curve length.

14. The method of claim 1, wherein when the object is a three-dimensional object, the object segmentation result is decomposed to a sequence of two-dimensional cross sections, and wherein the calculating, searching and replacing steps are repeated for the two-dimensional cross sections.

15. A system for regulating an object segmentation result to conform a shape of the object segmentation result to a pseudo-round type of shape, comprising:
a memory device for storing a program;
a processor in communication with the memory device, the processor operative with the program to:
calculate a set of shape-constraint measures at each point on a boundary of an object segmentation result;
search for one or more matched point pairs on the boundary of the object segmentation result; and
replace a boundary segment between a selected matched point pair with a smooth curve.

16. The system of claim 15, wherein calculating the set of shape-constraint measures comprises calculating a directional angle between a tangent and a directional line to an object center at each curve point, calculating a local average of a directional angle in an interval, and checking that substantially all points between a curve point and an object center are inside the object.

17. The system of claim 15, wherein calculating the set of shape-constraint measures comprises calculating α(t) and α̅(̅t̅)̅, where α̅(̅t̅)̅ represents a local average of a first directional angle in an interval ε(t) centered from t, and where α(t)=Φ((∂x(t)/∂t, ∂x(t)/∂t)\textcircled{×}(x_{c}−x(t),y_{c}−y(t))), where \textcircled{×} represents vector product and Φ represents a second directional angle between (∂x(t)/∂t,∂x(t)/∂t) and (x_{c}−x(t),y_{c}−y(t)).

18. The system of claim 15, wherein the processor is further operative with the program to repeat the calculating, searching and replacing steps until no matched pairs can be found for which a calculated value of at least one shape-constraint measure of the set of shape-constraint measures does not satisfy a shape-constraint measure condition.

19. The system of claim 18, wherein the shape-constraint measure conditions comprise α(t)>0 and α̅(̅t̅)̅≦θ, where α̅(̅t̅)̅ represents a local average of a first directional angle in an interval ε(t) starting from t, and where α(t)=Φ((∂x(t)/∂t,∂x(t)/∂t)\textcircled{×}(x_{c}−x(t),y_{c}−y(t))), where \textcircled{×} represents vector product and Φ represents a second directional angle between (∂x(t)/∂t,∂x(t)/∂t) and (x_{c}−x(t),y_{c}−y(t)).

20. The system of claim 19, wherein θ is a value larger than 90 degrees and less than 180 degrees.

21. A method of regulating the shape of an object segmentation result, comprising:
defining a set of shape-constraint measures to regulate segmented target objects;
searching for a pair of matched points on a boundary of an object segmentation result; and
interpolating between the matched points using local shape properties.

22. The method of claim 20, wherein the set of shape-constraint measures define a measurement criterion that characterizes a family of two-dimensional shapes.

23. The method of claim 21, wherein the family of two-dimensional shapes comprises compact, pseudo-round types of shapes.

24. The method of claim 21, wherein a pair of points on the boundary of the segmentation object are matched point pairs if, at both points, the calculated values of at least one shape-constraint measure of the set of shape-constraint measures does not satisfy a shape-constraint measure condition.
